(19) United States
(12) Patent Application Publication
(10) Pub. No.: US 2011/0049241 A1
(43) Pub. Date: Mar. 3, 2011

(54) Barcode Scanner

(75) Inventors: Ku-Yuan Chang, Taichung (TW); Fang-Bang Lin, Taichung (TW)

(73) Assignee: ASIA OPTICAL CO., INC., Taichung (TW)

(21) Appl. No.: 12/874,354

(22) Filed: Sep. 2, 2010

(30) Foreign Application Priority Data
Sep. 3, 2009 (TW) 98129683

(51) Int. Cl. G06K 7/14

(52) U.S. Cl. 235/462.41

(57) ABSTRACT

A barcode scanner. A lens set receives a barcode image and includes a first plastic lens, a second plastic lens, a diaphragm, a third plastic lens, and a low-pass filter sequentially arranged along an optical axis of the lens set. The first and third plastic lenses comprise convex lenses. The second plastic lens comprises a concave lens. An imaging member is separated from the lens set by a predetermined distance. The low-pass filter is disposed between the third plastic lens and the imaging member. The barcode image received by the lens set is imaged on the imaging member.

### CROSS REFERENCE TO RELATED APPLICATIONS

This Application claims priority of Taiwan Patent Application No. 098129683, filed on Sep. 3, 2009, the entirety of which is incorporated by reference herein.

### BACKGROUND OF THE INVENTION

1. Field of the Invention

The invention relates to a barcode scanner, and more particularly to a barcode scanner with reduced manufacturing costs and optical sensitivity.

2. Description of the Related Art

Barcode scanners have been widely employed in various fields. A conventional barcode scanner is mainly composed of a lens set and an imaging member. When the barcode scanner scans a barcode image, the barcode image is received by the lens set and the light beams thereof are imaged on the imaging member by refraction of the lens set. Scanning of the barcode image is thus achieved.

Nevertheless, as the lens set of the conventional barcode scanner comprises a plurality of glass lenses, manufacturing costs thereof are high.

Hence, there is a need for a barcode scanner with a lens set comprising a plurality of plastic lenses, reducing the overall manufacturing costs.

### BRIEF SUMMARY OF THE INVENTION

A detailed description is given in the following embodiments with reference to the accompanying drawings.

An exemplary embodiment of the invention provides a barcode scanner comprising a lens set and an imaging member. The lens set receives a barcode image and comprises a first plastic lens, a second plastic lens, a diaphragm, a third plastic lens, and a low-pass filter sequentially arranged along an optical axis of the lens set. The first and third plastic lenses comprise convex lenses. The second plastic lens comprises a concave lens. The imaging member is separated from the lens set by a predetermined distance. The low-pass filter is disposed between the third plastic lens and the imaging member. The barcode image received by the lens set is imaged on the imaging member.

The second plastic lens comprises an aspheric concave lens, and the third plastic lens comprises an aspheric convex lens.

The first, second, and third plastic lenses are respectively provided with a first focal length, a second focal length, and a third focal length. The ratio of the first focal length to the second focal length ranges between −2 and −1. The ratio of the second focal length to the third focal length ranges between −1 and 0.

The ratio of the first focal length to the second focal length is −1.268. The ratio of the second focal length to the third focal length is −0.522.

The first, second, and third focal lengths are 6.713 mm, −5.294 mm, and 10.139 mm, respectively.

### BRIEF DESCRIPTION OF THE DRAWINGS

The invention can be more fully understood by reading the subsequent detailed description and examples with references made to the accompanying drawings, wherein:

FIG. 1 is a schematic view showing the inner structure of a barcode scanner of the invention; and

FIG. 2 is a schematic view showing operation of the barcode scanner, of the invention, scanning a barcode image.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

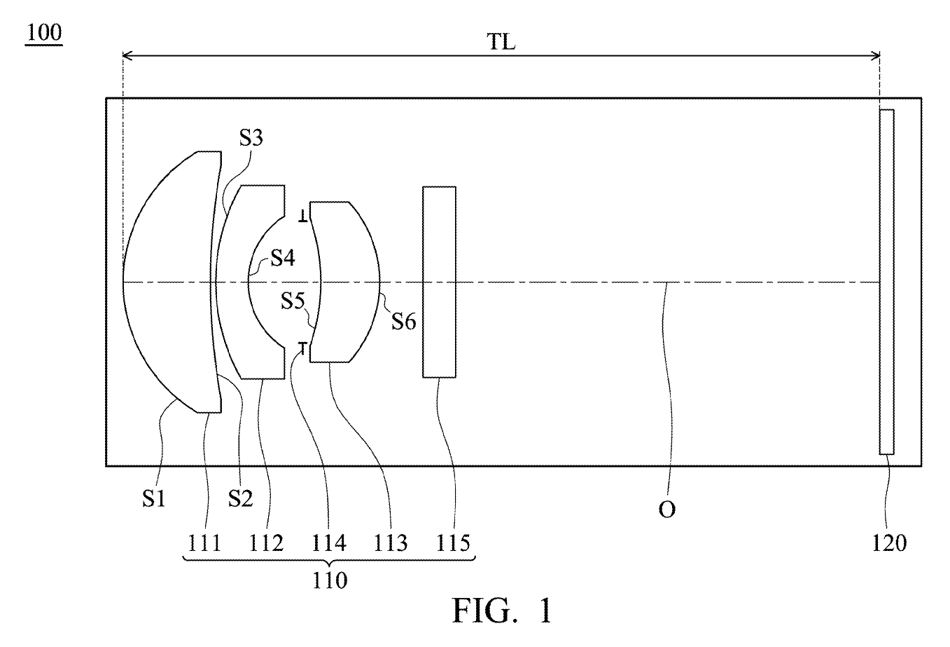

Referring to FIG. 1, a barcode scanner 100 comprises a lens set 110 and an imaging member 120.

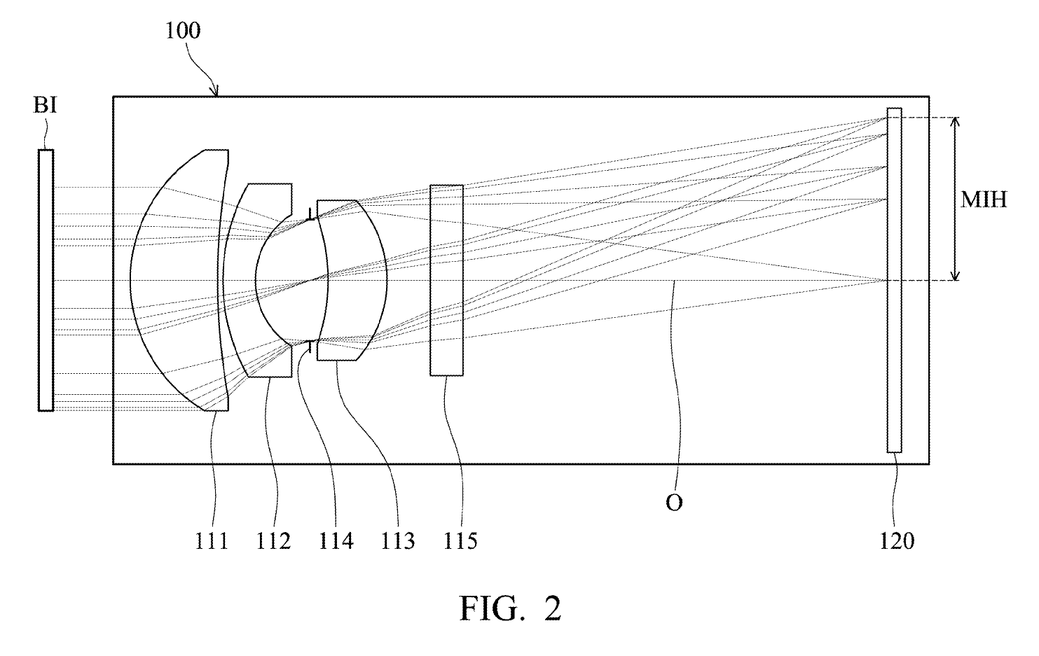

As shown in FIG. 1 and FIG. 2, the lens set 110 can receive a barcode image BI and comprises a first plastic lens 111, a second plastic lens 112, a diaphragm 114, a third plastic lens 113, and a low-pass filter 115 sequentially arranged along an optical axis 0 of the lens set 110. Moreover, the low-pass filter 115 may be a flat glass panel with a plating film.

The imaging member 120 is separated from the lens set 110 by a predetermined distance. Here, the low-pass filter 115 is disposed between the third plastic lens 113 and the imaging member 120. Moreover, the barcode image BI received by the lens set 110 is imaged on the imaging member 120.

In this embodiment, the first plastic lens 111 is a convex lens, the second plastic lens 112 is an aspheric concave lens, and the third plastic lens 113 is an aspheric convex lens. Moreover, the first plastic lens 111, second plastic lens 112, and third plastic lens 113 are respectively provided with a first focal length F1, a second focal length F2, and a third focal length F3. Specifically, the ratio of the first focal length F1 to the second focal length F2 ranges between −2 and −1 (i.e. −2<F1/F2<−1), and the ratio of the second focal length F2 to the third focal length F3 ranges between −1 and 0 (i.e. −1<F2/F3<0). More specifically, when the first focal length F1, second focal length F2, and third focal length F3 are respectively 6.713 mm, −5.294 mm, and 10.139 mm, the ratio of the first focal length F1 to the second focal length F2 is −1.268 and the ratio of the second focal length F2 to the third focal length F3 is −0.522. Additionally, when a maximum distance TL (as shown in FIG. 1) between the lens set 110 and the imaging member 120 is 13.883 mm and the numerical aperture of the diaphragm 114 is 3.705 mm, the focal length of the lens set 110 is 12 mm and a maximum imaging height MIH (as shown in FIG. 2) on the imaging member 120 is 3 mm. Here, the distance between the barcode image BI and the first plastic lens 111 is 200 mm.

Moreover, the specifications of the first plastic lens 111, second plastic lens 112, and third plastic lens 113 of the lens set 110 are as follows. As shown in FIG. 1, the first plastic lens 111 has a first lens surface S1 and a second lens surface S2, the second plastic lens 112 has a third lens surface S3 and a fourth lens surface S4, and the third plastic lens 113 has a fifth lens surface S5 and a sixth lens surface S6. The second lens surface S2 is adjacent to the third lens surface S3 and a minimum distance therebetween is 0.1 mm. The diaphragm 114 is disposed between the fourth lens surface S4 and the fifth lens surface S5. Specifically, the first lens surface S1 is a spherical surface while the second lens surface S2, third lens surface S3, fourth lens surface S4, fifth lens surface S5, and sixth lens surface S6 are aspheric surfaces. Additionally, the curvature radiuses of the first lens surface S1, second lens surface S2, third lens surface S3, fourth lens surface S4, fifth lens surface S5, and sixth lens surface S6 are 2.79 mm, 10.587 mm, 2.978 mm, 1.457 mm, −3.767 mm, and −2.428 mm, respectively. Here, the plus and minus signs denote different or opposite curvature directions. Furthermore, the maximum central thicknesses of the first plastic lens 111, second plastic lens 112, and third plastic lens 113 are 1.6 mm, 0.6 mm, and 1.08 mm, respectively.

Accordingly, when the barcode scanner 100 scans the barcode image BI, the barcode image BI is received by the lens set 110 and the light beams thereof are imaged on the imaging member 120 by refraction of the lens set 110 (as shown in FIG. 2). Scanning of the barcode image BI is thus achieved.

In conclusion, as all the lenses of the lens set 110 of the barcode scanner 100 are composed of plastic, overall manufacturing costs thereof can be effectively reduced. Additionally, as the diaphragm 114 is disposed between the second plastic lens 112 and the third plastic lens 113, optical sensitivity of the barcode scanner 100 or lens set 110 can be reduced, thereby enhancing assembly yield thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A barcode scanner, comprising:
a lens set receiving a barcode image and comprising a first plastic lens, a second plastic lens, a diaphragm, a third plastic lens, and a low-pass filter sequentially arranged along an optical axis of the lens set, wherein the first and third plastic lenses comprise convex lenses, and the second plastic lens comprises a concave lens; and
an imaging member separated from the lens set by a predetermined distance, wherein the low-pass filter is disposed between the third plastic lens and the imaging member, and the barcode image received by the lens set is imaged on the imaging member.

2. The barcode scanner as claimed in claim 1, wherein the second plastic lens comprises an aspheric concave lens, and the third plastic lens comprises an aspheric convex lens.

3. The barcode scanner as claimed in claim 2, wherein the first, second, and third plastic lenses are respectively provided with a first focal length, a second focal length, and a third focal length, and the ratio of the first focal length to the second focal length ranges between −2 and −1.

4. The barcode scanner as claimed in claim 2, wherein the ratio of the second focal length to the third focal length ranges between −1 and 0.
